(19) United States
(12) Patent Application Publication
(10) Pub. No.: US 2009/0284636 A1
(43) Pub. Date: Nov. 19, 2009

(54) DEVICE FOR DISPLAYING TAKEN IMAGE AND METHOD OF DISPLAYING TAKEN IMAGE

(75) Inventor: Kouji Hatano, Yokohama-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MATSUSHITA ELECTRIC INDUSTRIAL CO., LTD., Kadoma-shi, Osaka (JP)

(21) Appl. No.: 12/096,164

(22) PCT Filed: Mar. 2, 2006
(86) PCT No.: PCT/JP2006/304003

§ 371 Date: Jun. 4, 2008

(30) Foreign Application Priority Data
Dec. 21, 2005 (JP) 2005-367710

(51) Int. Cl. H04N 5/225

(52) U.S. Cl. 348/333.11; 348/E05.024

(57) ABSTRACT

A camera-equipped mobile telephone terminal with which a portion that the user can not view can be confirmed with simple operation. In the mobile telephone terminal (1), when the user operates an operation member, operation detection means (2) detects that display of image data is operated. When the operation detection means (2) detects the start of operation, imaging means (3) images an object and creates image data. During a period from when the start of the operation is detected until the end of the operation is detected, display means (4) holds display of the image data created by the imaging means (3) from the time at which the operation detection means (2) detects the start of the operation until the time at which the operation detection means detects the end of the operation. When the operation detection means (2) detects the end of the operation, the display means (4) ends the display of the image data.

### TECHNICAL FIELD

The present invention relates to an apparatus that photographs and displays an image of a photographing object. More particularly, the present invention relates to a photographed image display apparatus applicable to a portable electronic apparatus having a photographing function.

### BACKGROUND ART

Cellular phone terminals are being implemented with higher performance in recent years and cellular phone terminals with photographing functions in addition to a call function and communication function are already becoming widespread. Many cellular phone terminals with photographing functions are provided with a photographing element and a display, and configured so as to display photographed images on the display. This configuration allows a user to photograph the photographing object while checking the image on the display of the cellular phone terminal, save or erase photographed image data.

Among cellular phone terminals with photographing functions, those configured to photograph not only a photographing object near the user but also the user himself/herself and display image on the display, are also proposed. According to this invention, the user can check his/her face or the like when photographing himself/herself. Furthermore, according to this invention, it is possible to use the cellular phone terminal not only to photograph and save a photographing object image but also as a substitute for a “hand glass” (e.g., see Patent Document 1).

### Patent Document 1: Japanese Patent Application Laid-Open No. 2003-169116 (p 9, FIG. 1)

### DISCLOSURE OF INVENTION

### Problems to be Solved by the Invention

However, the above described conventional cellular phone terminal has a problem that though the user's condition can be checked from front, the user's condition in the back cannot be checked such as the back of the head cannot be checked.

Furthermore, there is also a method of photographing the user's back using the above described conventional cellular phone terminal, show and check the photographed image on the display, but there is a problem that after checking the image, the user needs to proceed with an erasure operation such as pressing an erasure button or selecting a menu to finish a displayed screen on the display, which complicates the operation.

It is therefore an object of the present invention to solve the above described conventional problems and provide a photographed image display apparatus that allows the user to check parts that cannot be visually checked through a simple operation.

### Means for Solving the Problem

The photographed image display apparatus of the present invention adopts a configuration including: an operation detection section that detects an operation of displaying image data by an action upon an operator by a user; an photographing section that takes a photograph of a photographing object and generates image data; and a display section that holds a display of the image data generated by the photographing section after the operation detection section detects a start of the operation, until an end of the operation is detected, and finishes the display of the image data when the operation detection section detects the end of the operation.

The photographed image display method of the present invention adopts a method including: a first step of detecting an operation of displaying image data by an on an operator by the user; a second step of taking a photograph of a photographing object and generating image data; a third step of holding a display of the image data generated when a start of the operation is detected; a fourth step of detecting an end of the operation; and a fifth step of finishing the display of the image data when the end of the operation is detected.

### ADVANTAGEOUS EFFECT OF THE INVENTION

According to the present invention, the photographed image displayed based on the detection of the start of operation by the operation detection section is erased based on the detection of the end of operation, so that the user can check parts that cannot be visually checked through a simple operation.

### BRIEF DESCRIPTION OF DRAWINGS

FIG. 1 shows a schematic configuration diagram of a photographed image display apparatus according to Embodiment 1 of the present invention;

FIG. 2 is a configuration diagram of a digital camera according to Embodiment 1 of the present invention;

FIG. 3A is a first appearance of the digital camera according to Embodiment 1 of the present invention;

FIG. 3B is a second appearance of the digital camera according to Embodiment 1 of the present invention;

FIG. 4 is a flowchart showing a procedure by the display control section of the digital camera according to Embodiment 1 of the present invention;

FIG. 5 illustrates the operation of the digital camera according to Embodiment 1 of the present invention;

FIG. 6 illustrates the operation of the digital camera according to Embodiment 1 of the present invention;

FIG. 7 illustrates the operation of the digital camera according to Embodiment 1 of the present invention;

FIG. 8 illustrates the operation of the digital camera according to Embodiment 1 of the present invention;

FIG. 9 illustrates the operation of the digital camera according to Embodiment 1 of the present invention;

FIG. 10 is a schematic configuration of a photographed image display apparatus according to Embodiment 2 of the present invention;

FIG. 11 is a configuration diagram of a cellular phone terminal according to Embodiment 2 of the present invention;

FIG. 12 is a first appearance of the cellular phone terminal according to Embodiment 2 of the present invention;

FIG. 13 is a second appearance of the cellular phone terminal according to Embodiment 2 of the present invention;

FIG. 14 is a flowchart showing a procedure by the display control section of the cellular phone terminal according to Embodiment 2 of the present invention;

FIG. 15 is a flowchart showing a procedure by the save control section according to Embodiment 2 of the present invention;

FIG. 16 illustrates the operation of the cellular phone terminal according to Embodiment 2 of the present invention;

FIG. 17 illustrates the operation of the cellular phone terminal according to Embodiment 2 of the present invention;

FIG. 18 illustrates the operation of the cellular phone terminal according to Embodiment 2 of the present invention;

FIG. 19 illustrates the operation of the cellular phone terminal according to Embodiment 2 of the present invention;

FIG. 20 illustrates the operation of the cellular phone terminal according to Embodiment 2 of the present invention;

FIG. 21 illustrates the operation of the cellular phone terminal according to Embodiment 2 of the present invention;

FIG. 22 illustrates the operation of the cellular phone terminal according to Embodiment 2 of the present invention;

FIG. 23 illustrates the operation of the cellular phone terminal according to Embodiment 2 of the present invention;

FIG. 24 illustrates the operation of the cellular phone terminal according to Embodiment 2 of the present invention; and

FIG. 25 illustrates the operation of the cellular phone terminal according to Embodiment 2 of the present invention.

### BEST MODE FOR CARRYING OUT THE INVENTION

Preferred embodiments of the present invention will be explained in detail hereinafter with reference to the accompanying drawings. In all drawings to explain the embodiments, the same components will be assigned the same reference numerals and overlapping explanations will be omitted.

### Embodiment 1

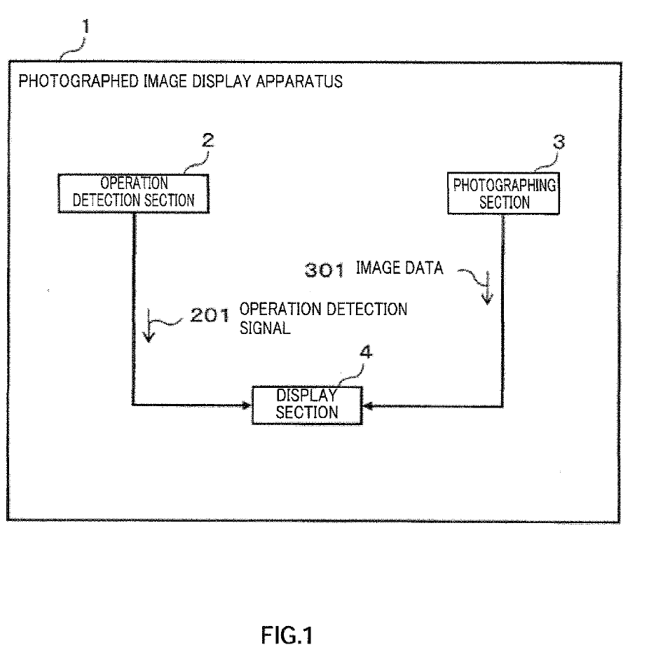

FIG. 1 is a schematic configuration of photographed image display apparatus 1 according to Embodiment 1 of the present invention. In FIG. 1, photographed image display apparatus 1 is provided with operation detection section 2, photographing section 3 and display section 4.

Operation detection section 2 detects an operation and outputs operation detection signal 201. Photographing section 3 takes a photograph of a photographing object and outputs image data 301. Display section 4 displays image data 301 based on operation detection signal 201.

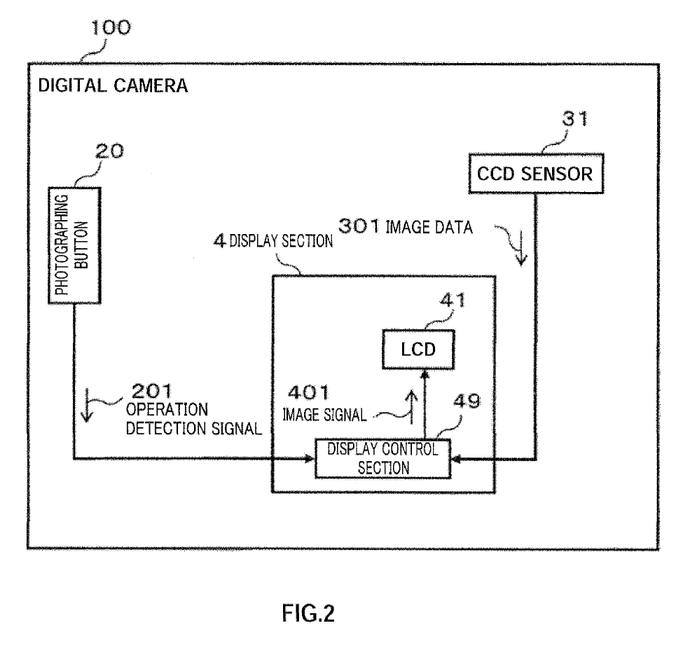

FIG. 2 is a configuration diagram when photographed image display apparatus 1 is applied to digital camera 100 according to Embodiment 1 of the present invention.

In FIG. 2, digital camera 100 is provided with photographing button 20 as operation detection section 2, which is a component explained in FIG. 1, image sensor 31 using a charge coupled device (charge coupled device image sensor, hereinafter abbreviated as a “CCD sensor”) as photographing section 3, and display control section 49 and liquid crystal display section (liquid crystal display, hereinafter abbreviated as “LCD”) 41 as display section 4.

Photographing button 20 outputs “press” upon detecting a start of a press operation and outputs “release” upon detecting an end of press operation as operation detection signal 201. Display control section 49 outputs image signal 401, which is a signal for displaying image data 301, based on operation detection signal 201. LCD 41 displays image signal 401 in a visible manner.

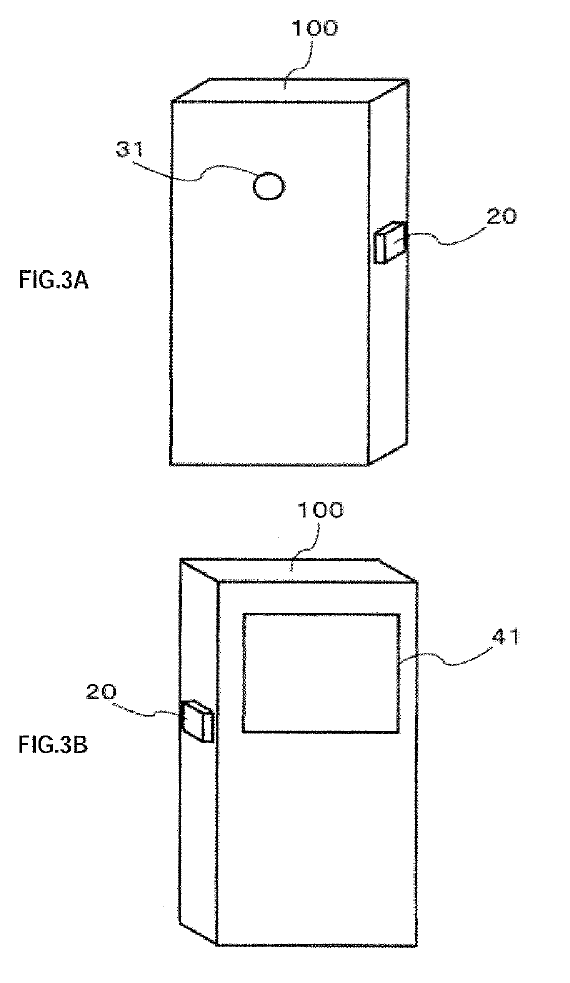

FIG. 3A and FIG. 3B show an appearance of digital camera 100 according to Embodiment 1 of the present invention. As shown in FIG. 3A, CCD sensor 31 is provided in the front of the casing of digital camera 100. Furthermore, photographing button 20 is provided on a side of the casing. FIG. 3B shows an appearance of digital camera 100 shown in FIG. 3A viewed from the back. As shown in FIG. 3B, LCD 41 is provided on the back of CCD sensor 31. The provision of photographing button 20 on the side of digital camera 100 makes it easier for the user to operate photographing button 20 while holding digital camera 100 in the back.

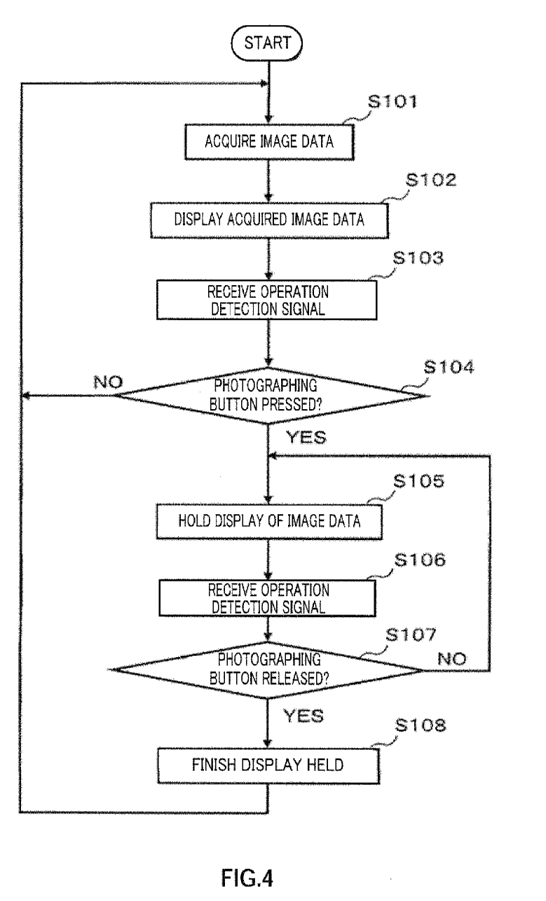

The operation of Embodiment 1 of the present invention will be explained below. FIG. 4 is a flowchart showing a procedure by display control section 49 of digital camera 100 according to Embodiment 1 of the present invention.

First, in step S101, display control section 49 acquires image data 301 of the photographing object from CCD sensor 31 and outputs image signal 401 for displaying acquired image data 301 acquired in step S102 to LCD 41. This causes image data 301 to be displayed on LCD 41.

Next, in step S103, display control section 49 receives operation detection signal 201. When received operation detection signal 201 is “release” (step S104: “NO”), display control section 49 starts the processing from step S101 again.

When received operation detection signal 201 is “press” (step S104: “YES”), display control section 49 outputs image signal 401 so as to continue displaying display image data 301 in step S105. This causes the display of image data 301 to be continued. After the processing in step S105 is carried out, even if the image of the photographing object changes due to variations in the position and angle of digital camera 100, the image displayed on LCD 41 is not erased or updated, and the display condition of LCD 41 at the time the processing in step S105 is carried out is maintained.

Furthermore, display control section 49 receives operation detection signal 201 in step S106. When received operation detection signal 201 is “press” (step S107: “NO”), display control section 49 starts the processing from step S105 again.

When received operation detection signal 201 is “release” (step S107: “YES”), display control section 49 finishes displaying image data 301 in step S108.

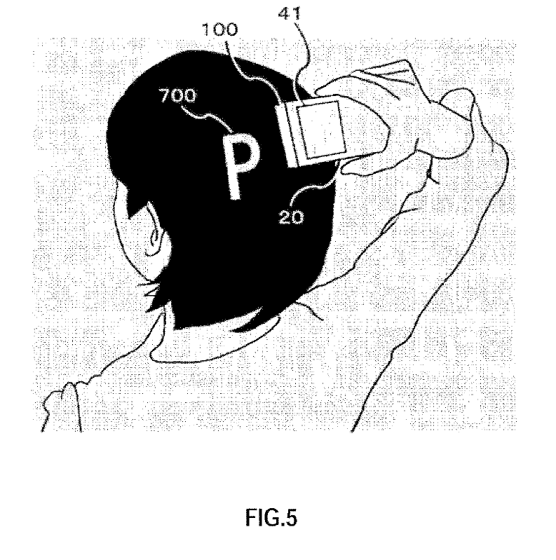

FIG. 5 to FIG. 9 illustrate operations of digital camera 100 according to Embodiment 1 of the present invention. FIG. 5 to FIG. 9 explain how the user checks the condition of the back of the user's head using digital camera 100 by way of example. Hereinafter, operations of digital camera 100 according to Embodiment 1 of the present invention centered on FIG. 5 to FIG. 9. For ease of explanation, suppose the letter “P” written in the back of the user's head is photographing object 700, which is the target to check.

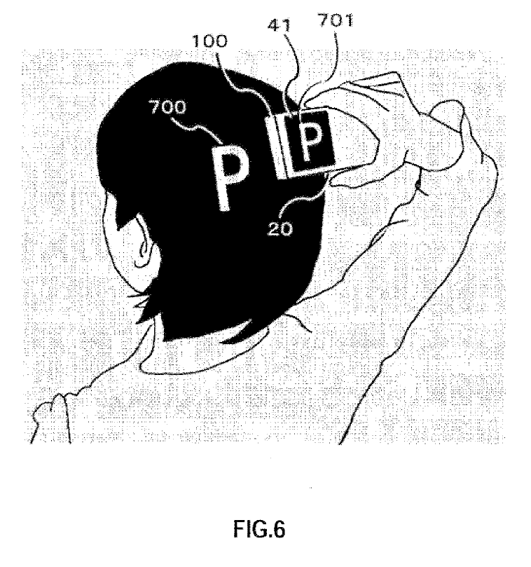

First, as shown in FIG. 5, when the user holds digital camera 100 so that CCD sensor 31 faces the front of photographing object 700 of the back of the head, display control section 49 acquires image data 301 of photographing object 700 in step S101 of FIG. 4. In step S102, when display control section 49 outputs image signal 401 so as to display image data 301 on LCD 41, image 701 of photographing object 700 is displayed on LCD 41 (FIG. 6).

Next, display control section 49 receives operation detection signal 201 in step S103. Display control section 49 then repeats the processing from step S101 to step S104 until the user presses photographing button 20. During this period, image 701 of photographing object 700 displayed on LCD 41 continues to be updated.

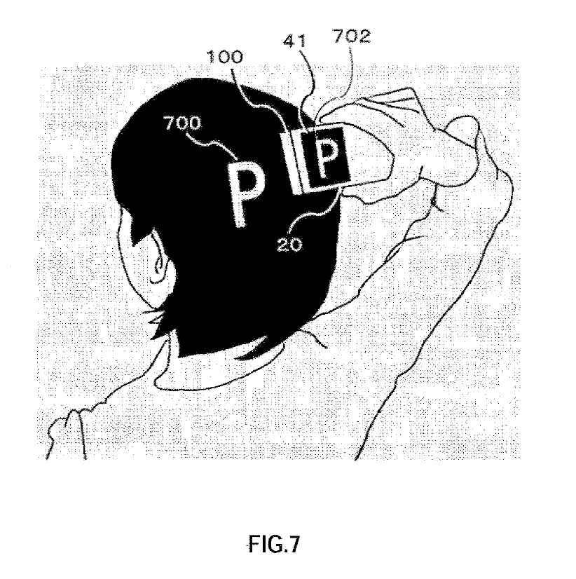

When the user presses photographing button 20 here (FIG. 7), display control section 49 detects the operation detection signal “press” (step S104: “YES”) and holds display 702 of image data 301 of photographing object 700 acquired immediately before in step S105.

Next, display control section 49 receives operation detection signal 201 “press” in step S106 and display control section 49 repeats the processing from step S105 to step S107 until the user releases photographing button 20, whereby image 702 of photographing object 700 displayed on LCD 41 is held without being updated.

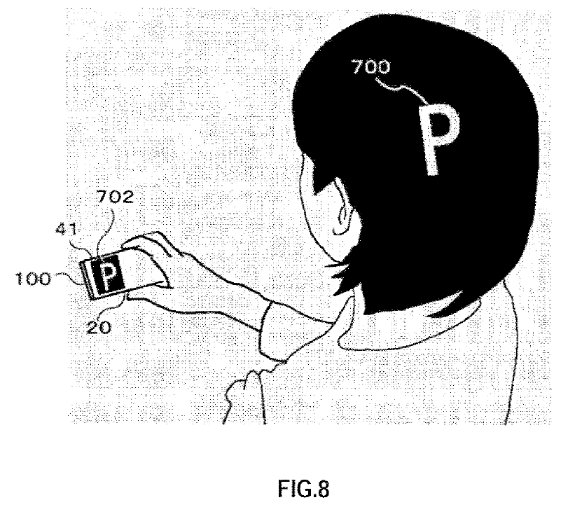

When the user moves digital camera 100 to the front of the eyes while keeping photographing button 20 pressed and visually checks image 702, so that the user can check photographing object 700, that is, the condition of the back of the user's head (FIG. 8).

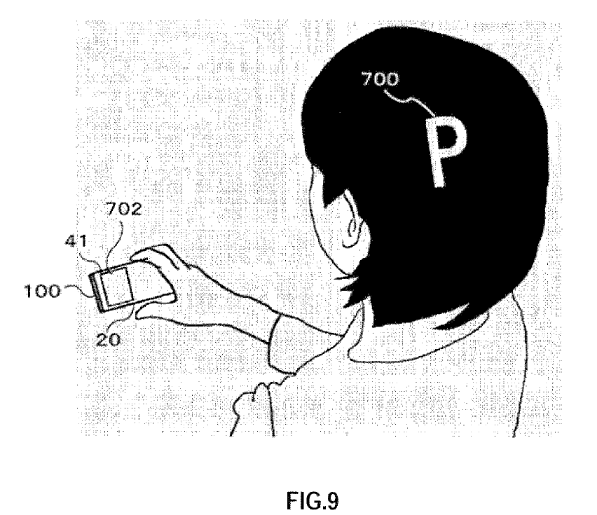

When the user releases photographing button 20 after checking the condition of the back of the head (FIG. 9), display control section 49 receives the operation detection signal “release” in step S106, moves to “YES” according to the decision in step S107 and finishes display 702 in step S108.

As explained above, Embodiment 1 of the present invention configures digital camera 100 so that the display of image data 301 is held when photographing button 20 is pressed and the display of image data 301 is finished by the release of photographing button 20, that is, by the end of press operation. In this way, the photographed image data displayed through press operation using photographing button 20 can be erased by only releasing photographing button 20, so that the user can check parts that cannot be checked visually, such as the back of the head, by simple operations.

### Embodiment 2

Next, Embodiment 2 of the present invention will be explained. Embodiment 2 of the present invention is configured to add an image saving section that saves photographed image data and an photographing notifying section that notifies to the surrounding that a photograph is being taken to the configuration of Embodiment 1 of the present invention which has already been explained, so that when saving the image data, the photographing notifying section issues a notification, whereas when not saving the image data, the photographing notifying section does not issue a notification. Embodiment 2 of the present invention is also configured so that the display section displays image data rotated in a predetermined direction with respect to the direction of the photographing object.

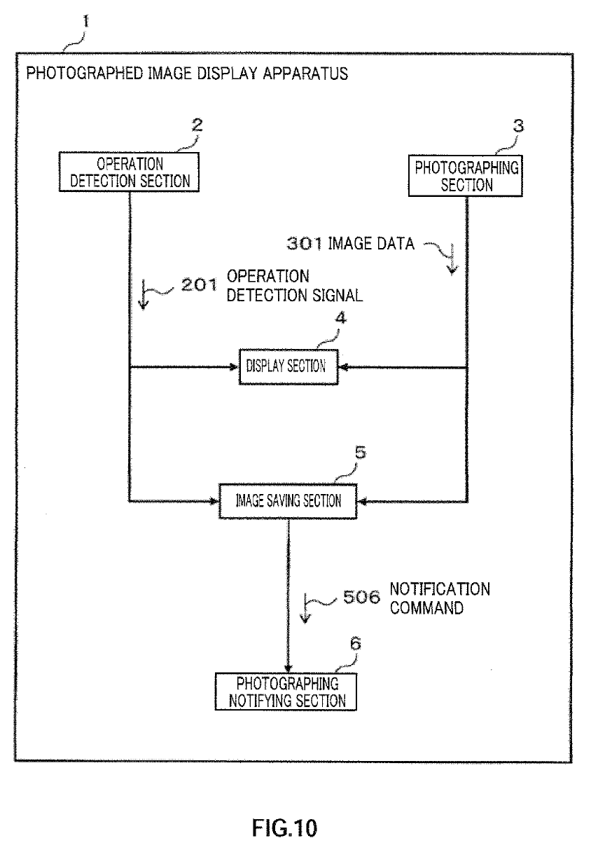

FIG. 10 is a schematic configuration of photographed image display apparatus 1 according to Embodiment 2 of the present invention. In FIG. 10, photographed image display apparatus 1 is provided with image saving section 5 and photographing notifying section 6 in addition to the components of photographed image display apparatus in Embodiment 1 shown in FIG. 1.

Image saving section 5 saves image data 301 based on operation detection signal 201. Furthermore, image saving section 5 outputs notification command 506 for notifying to the surrounding that a photograph is being taken, based on operation detection signal 201. Photographing notifying section 6 notifies that a photograph is being taken based on notification command 506.

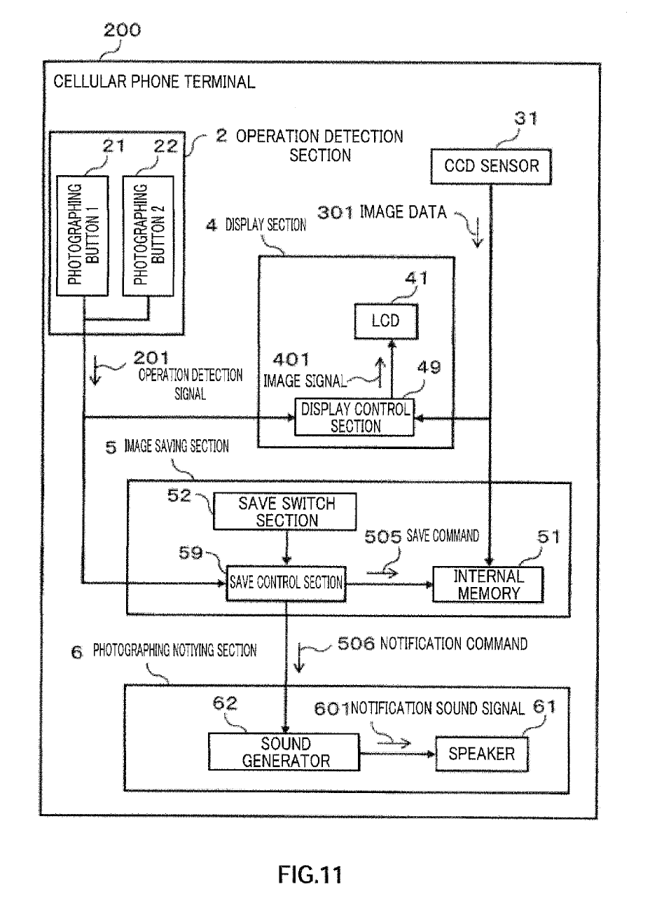

FIG. 11 is a configuration diagram when photographed image display apparatus 1 according to Embodiment 2 of the present invention is provided for cellular phone terminal 200. In FIG. 11, cellular phone terminal 200 is provided with first photographing button 21 and second photographing button 22 as operation detection section 2, which is a component explained in FIG. 10, save control section 59, internal memory 51 and save switch section 52 as image saving section 5, and sound generator 62 and speaker 61 as photographing notifying section 6.

First photographing button 21 and second photographing button 22 detect a start of a press operation and output “1 press” and “2 press” as operation detection signal 201 respectively. Furthermore, first photographing button 21 and second photographing button 22 detect an end of press operation and both buttons output “release” as operation detection signal 201.

Display control section 49 outputs image signal 401, which is a signal to display image data 301, based on operation detection signal 201. In this case, display control section 49 outputs image signal 401 to display an image subjected to processing of any one of left-to-right inversion, 90-degree clockwise rotation and 90-degree counterclockwise rotation on image data 301. Display control section 49 is comprised of, for example, a central processing unit (hereinafter abbreviated as “CPU”), software operating on the CPU, graphics controller and driver software that drives the graphics controller.

Save control section 59 outputs save command 505, which is a command for saving image data 301 based on operation detection signal 201. Furthermore, save control section 59 outputs notification command 506 based on operation detection signal 201. Save control section 59 is comprised of a CPU and software operating on the CPU or the like.

Internal memory 51 saves image data 301 based on save command 505. Save switch section 52 is a means for switching between saving and not saving image data 301 in internal memory 51.

Sound generator 62 outputs notification sound signal 601, which is a signal showing the waveform of a notification sound, based on notification command 506. Speaker 61 converts notification sound signal 601 to vibration and outputs sound.

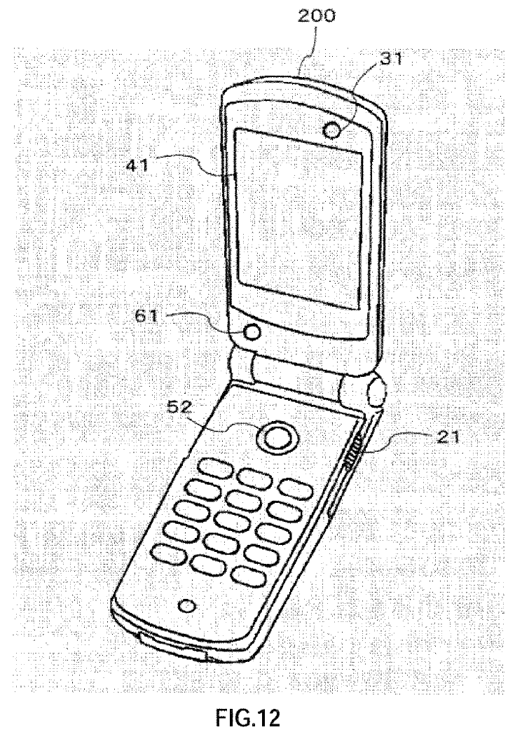

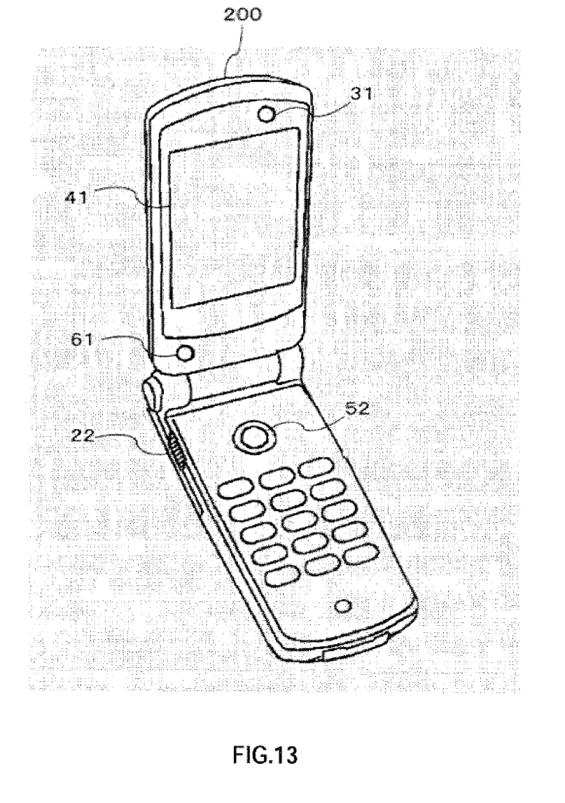

FIG. 12 and FIG. 13 show an appearance of cellular phone terminal 200 of Embodiment 2 of the present invention. As shown in FIG. 12 and FIG. 13, CCD sensor 31 is provided on the same side as LCD 41. Furthermore, first photographing button 21 and second photographing button 22 are provided on mutually opposite sides so that the user can operate first photographing button 21 when operating the button by the right hand and operate second photographing button 22 when operating the button by the left hand. By providing a plurality of operators on different sides of the casing as operation detection section 2 in this way, photographed image display apparatus 1 can decide by which of the right hand or left hand the user holds the casing.

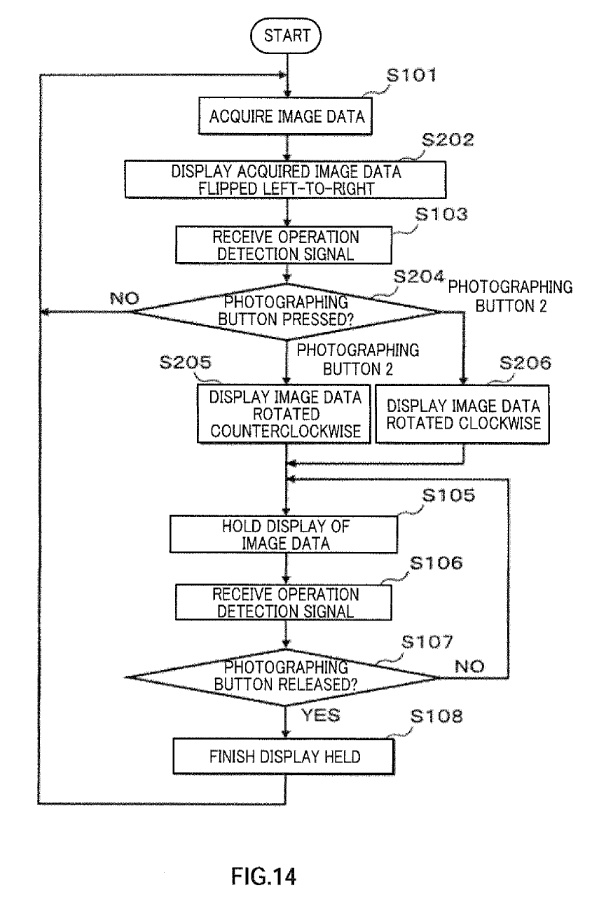

Hereinafter, the operation of Embodiment 2 of the present invention will be explained. FIG. 14 is a flowchart showing a procedure by display control section 49 of cellular phone terminal 200 according to Embodiment 2 of the present invention. In step S202, display control section 49 outputs image signal 401 so as to display acquired image data 301 flipped left-to-right.

In step S204, display control section 49 decides whether received operation detection signal 201 is “1 press” or “2 press,” that is, whether first photographing button 21 is pressed or second photographing button 22 is pressed. When received operation detection signal 201 is “release” (step S204: “NO”), display control section 49 states the processing from step S101 once again.

When received operation detection signal 201 is “1 press” (step S204, photographing button 1), display control section 49 outputs image signal 401 so as to display image data 301 on LCD 41 rotated counterclockwise by 90 degrees in step S205. On the other hand, when received operation detection signal 201 is “2 press” (step S204, photographing button 2), display control section 49 outputs image signal 401 so as to display image data 301 on LCD 41 rotated clockwise by 90 degrees in step S206.

In step S202, display control section 49 gives a command so as to display image data 301 flipped left-to-right because by that means the user can check the condition of the user's front with a mirror image using cellular phone terminal 200. When display control section 59 carries out the processing in step S202, the user need not perform any different operation for switching the display when checking the condition of the front and when checking the condition of the back, so that the user can check the conditions of the user's front and back by a simple operation.

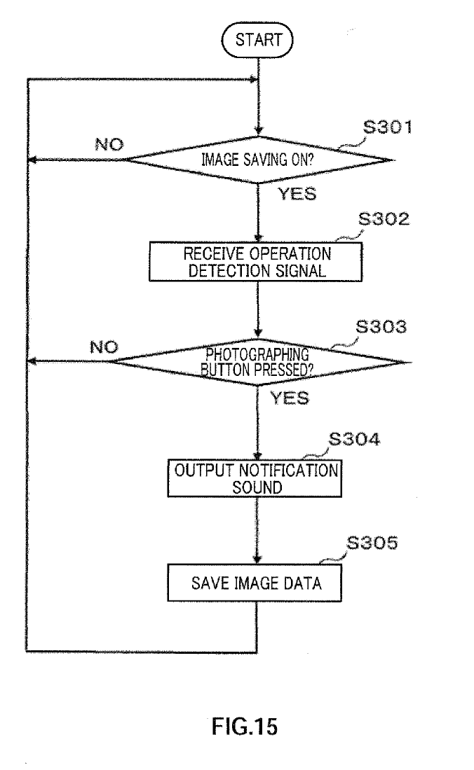

FIG. 15 is a flowchart showing a procedure by save control section 59 of cellular phone terminal 200 according to Embodiment 2 of the present invention. First, when the switching condition of save switch section 52 is switched so as to save image data 301 in internal memory 51 (step S301: “YES”)/save control section 59 receives operation detection signal 201 in step S302. On the other hand, when the switching condition of save switch section 52 is switched so as not to save image data 301 in internal memory 51 (step S301: “NO”), save control section 59 does not perform any processing.

Next, in step S303, save control section 59 decides which of first photographing button 21 or second photographing button 22 is pressed based on received operation detection signal 201. When no button is pressed (step S303: “NO”), save control section 59 does not perform any processing.

When either of the two buttons is pressed (step S303: “YES”) and when save control section 59 outputs notification command 506 to output a notification sound in step S304, sound generator 62 outputs notification sound signal 601 and speaker 61 outputs a notification sound. When save control section 59 outputs save command 505 to save image data 301 in step S305, internal memory 51 saves image data 301.

As has been explained using FIG. 15 so far, photographing notifying section 6 of cellular phone terminal 200 according to Embodiment 2 of the present invention notifies to the surrounding in step S304 that a photograph has been taken based on operation detection signal 201 received in step S302 when save switch section 52 is switched so as to save image data 301 and does not notify anything when save switch section 52 is switched so as not to save image data 301.

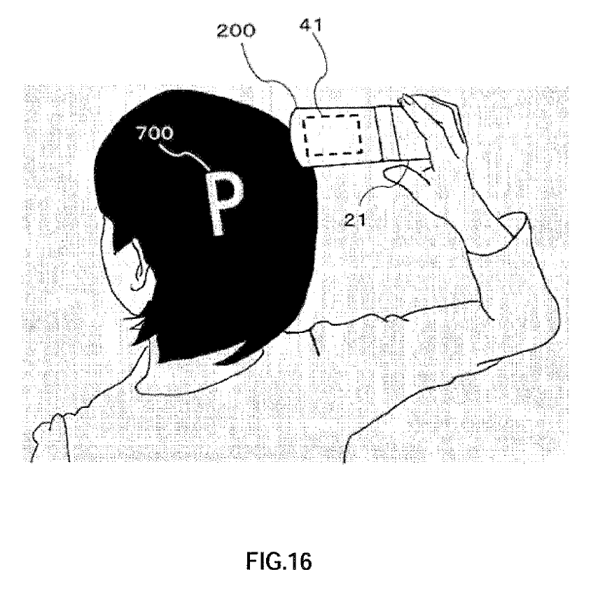

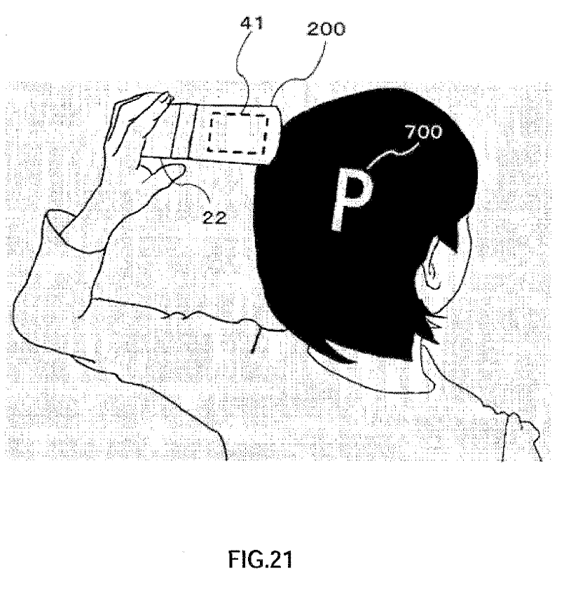

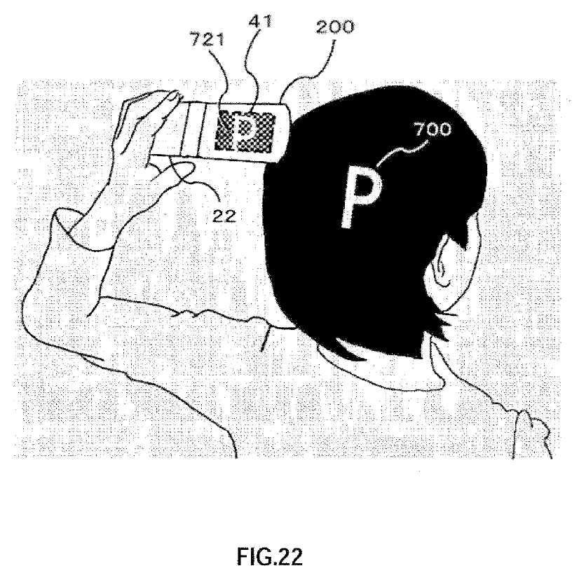

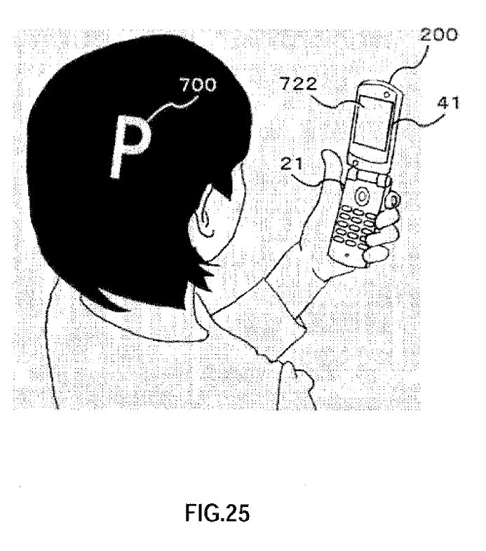

FIG. 16 to FIG. 25 illustrate operations of cellular phone terminal 200 according to Embodiment 2 of the present invention. FIG. 16 to FIG. 20 explain how the user checks the condition of the back of the head by holding cellular phone terminal 200 by the right hand and FIG. 21 to FIG. 25 explain how the user checks the condition of the back of the head by holding cellular phone terminal 200 by the left hand. Hereinafter, operations of cellular phone terminal 200 according to Embodiment 2 of the present invention will be explained centered on FIG. 16 to FIG. 25.

The operations shown in FIG. 16 to FIG. 25 will be explained assuming that save switch section 52 is switched so as not to save image data 301 in internal memory 51. Furthermore, in FIG. 16 to FIG. 18 and FIG. 21 to FIG. 23, since LCD 41 and image 711, image 712, image 721 and image 722 displayed on LCD 41 are located on the back of the casing of cellular phone terminal 200, these cannot be seen but they are described using dotted lines in the figures for ease of explanation.

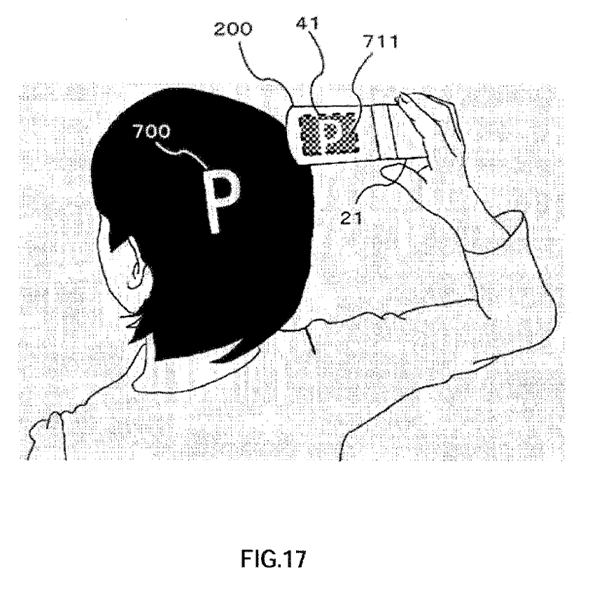

First, as shown in FIG. 16, when the user holds cellular phone terminal 200 by the right hand so that CCD sensor 31 faces the front of photographing object 700 of the back of the head, display control section 49 acquires image data 301 of photographing object 700 in step S101 of FIG. 14. When display control section 49 outputs image signal 401 so that image data 301 is displayed flipped left-to-right in step S202, an image flipped left-to-right with respect to photographing object 700, that is, image 711 which is a mirror image of photographing object 700 is displayed on LCD 41 (FIG. 17).

Display control section 49 receives operation detection signal 201 in step S103. When first photographing button 21 is not pressed (step S204: “NO”), display control section 49 starts the processing from step S101 once again. When display control section 49 repeats the processing from step S101 to step S204 until the user presses first photographing button 21, image 711 of photographing object 700 displayed on LCD 41 thereby continues to be updated.

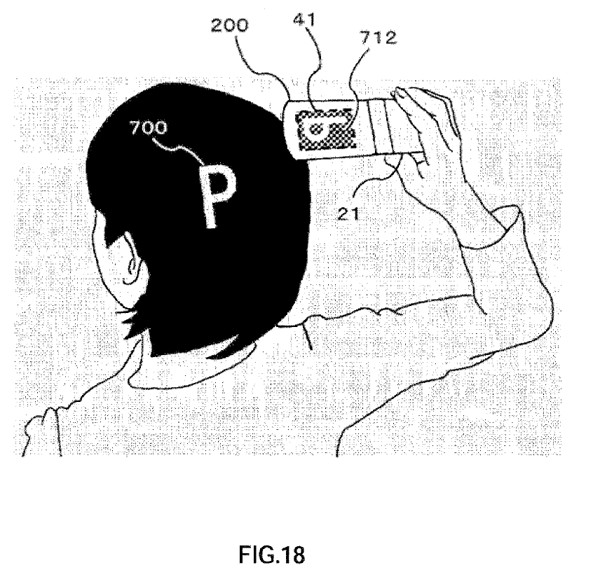

When the user presses first photographing button 21 here (FIG. 18), display control section 49 receives operation detection signal “1 press” in step S103 (step 3204, photographing button 1) and display control section 49 outputs image signal 401 so as to rotate image data 301 counterclockwise by 90 degrees in step S205. This causes image 712 to be displayed on LCD 41, rotated counterclockwise by 90 degrees with respect to photographing object 700. Next, when display control section 49 performs the processing in step S105, the display of image 712 resulting from rotating image data 301 of photographing object 700 counterclockwise by 90 degrees is held.

On the other hand, when the user presses first photographing button 21, save control section 59 performs processing according to the flowchart shown in FIG. 15, but since the decision in step S301 is “NO,” the processing from step S302 onward will not be performed, and neither notifying to the surrounding nor saving of image data 301 is performed.

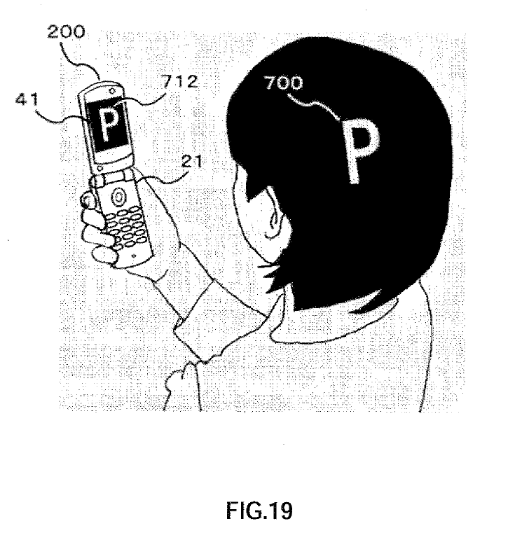

When the user moves cellular phone terminal 200 to the front of the eyes while keeping first photographing button 21 pressed and visually checks image 712, the user can check the condition of photographing object 700, that is, the condition of the back of the user's head (FIG. 19)

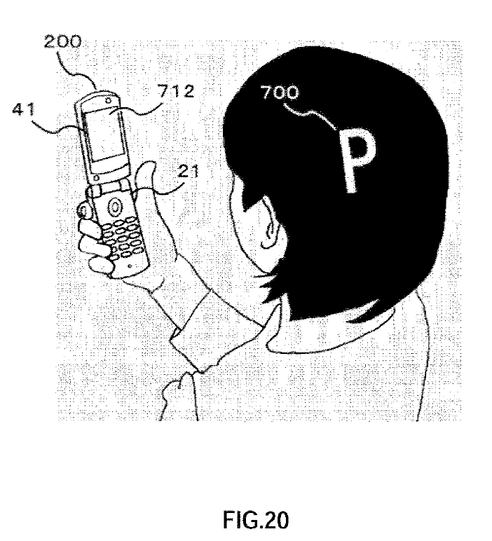

When the user releases first photographing button 21 after checking the condition of the back of the head (FIG. 20), display control section 49 receives an operation detection signal “release” in step S106 (step S107: “YES”) and finishes display 712 in step S108.

When the user visually checks image 712 in FIG. 19, the casing of cellular phone terminal 200 is held in a direction different from the direction of the casing in FIG. 16 to FIG. 18, but since image data 301 is displayed on LCD 41 rotated beforehand through the processing in step S205, the user can check photographing object 700 in an appropriate direction.

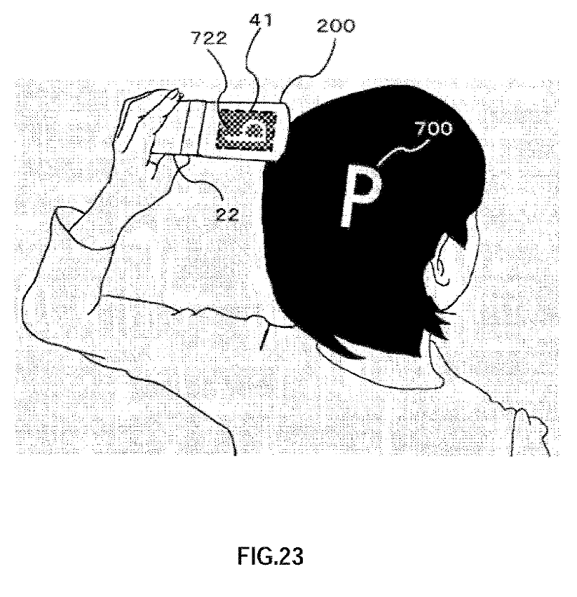

When the user holds cellular phone terminal 200 according to Embodiment 2 of the present invention by the left hand, the user operates it through processing similar to that when the user holds cellular phone terminal 200 by the right hand, but since the user presses second photographing button 22 in FIG. 23, display control section 49 carries out processing in step S206 instead of step S205. Therefore, as shown in FIG. 23, display image 722 is displayed on LCD 41 rotated clockwise by 90 degrees as opposed to the case where cellular phone terminal 200 is held by the right hand.

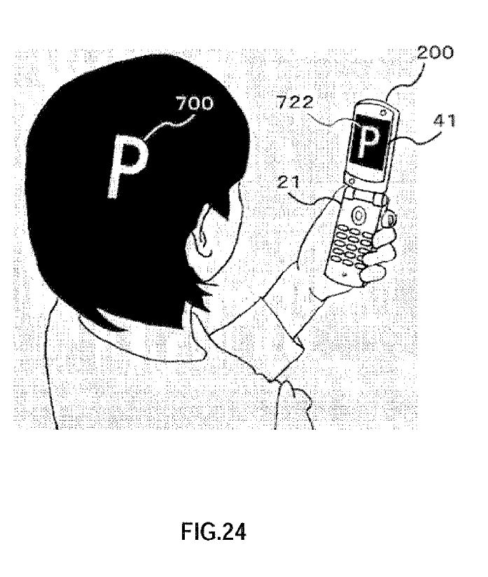

By carrying out processing of rotating display image 722 by 90 degrees in a direction opposite to that in the case of holding the cellular phone terminal by the right hand in step S206, the user can check photographing object 700 in an appropriate direction by visually checking display image 722 (FIG. 24).

As explained above, cellular phone terminal 200 according to Embodiment 2 of the present invention is configured so as to display image data 301 on LCD 41, rotated in a predetermined direction with respect to the direction of the photographing object based on operation detection signal 201. This allows photographed image data 301 to be displayed on LCD 41 in an appropriate direction, thereby eliminating the necessity for the user to carry out an operation of switching the hand to hold cellular phone terminal 200 to check photographed image data 301 and allowing the user to check parts that cannot be visually checked such as the back of the head through a simple operation.

Furthermore, cellular phone terminal 200 according to Embodiment 2 of the present invention is provided with first photographing button 21 and second photographing button 22 on different sides of the casing, displays image data 301 by rotating it in different directions when first photographing button 21 is pressed and when second photographing button 22 is pressed. This allows the user to display photographed image data 301 on LCD 41 in an appropriate direction regardless of whether the user holds cellular phone terminal 200 by the left hand or right hand and eliminates the necessity for the user to carry out any operation of switching the hand to hold cellular phone terminal 200 to check photographed image data 301, thereby allowing the user to check parts that cannot be visually checked through a simple operation.

Furthermore, when save switch section 52 is switched so as to save image data 301 in internal memory 51, cellular phone terminal 200 according to Embodiment 2 of the present invention outputs a notification sound from speaker 61, whereas when save switch section 52 is switched so as not to save image data 301 in internal memory 51, cellular phone terminal 200 is configured so as not to output any notification sound from speaker 61. This prevents the inconvenience of drawing attention from people around by a sudden notification sound every time first photographing button 21 or second photographing button 22 is operated and allows the user to check parts that cannot be visually checked through a simple operation and at the same time improves convenience.

The embodiments of the present invention have assumed that the operation detection section is provided with one operator or two operators operated independently of each other, but the present invention is not limited to this and by providing, for example, an operator for detecting pressing with a finger and another operator for detecting touching with the palm of a hand separately and performing processing based on a combination of operations by a plurality of operation detection sections such as deciding a casing holding condition based on which operator detects operations simultaneously, it is possible to decide the casing holding condition more accurately and thereby implement the present invention more adequately.

Furthermore, according to Embodiment 2 of the present invention, when the image saving section does not save image data, the photographing notifying section does not issue a notification, but the point is to differentiate the notifying operation depending on whether image data is saved or not, and for example, a notification sound may be set to a lower sound level or set to output for a shorter time or a notification sound of a different frequency may be outputted when the image data is not saved compared to the case where the image data is saved, or light may be used for notifying when the image data is not saved or the like.

Furthermore, the display section of the present invention need not hold image data as still images when the operation detection section starts operation, and, for example, the display section may be provided with a storage section that stores a plurality of pieces of image data, the storage section may temporarily store image data photographed for a predetermined time before the operation detection section starts operation and the stored image data may be displayed as moving images on the display section when the operation detection section starts operation.

The embodiments of the present invention have explained the digital camera and cellular phone terminal as an example, but the present invention is not limited to this and the present invention can be applied to any electronic apparatus provided with an operation detection section, photographing section and display section.

The present application is based on Japanese Patent Application No. 2005-367710, filed on Dec. 21, 2005, the entire content of which is expressly incorporated by reference herein.

### INDUSTRIAL APPLICABILITY

The photographed image display apparatus and photographed image display method of the present invention provide an effect of allowing the user to check parts that cannot be visually checked through a simple operation and are suitable for use in a portable electronic apparatus having photographing functions.

1. A photographed image display apparatus comprising:
an operation detection section that detects an operation of displaying image data by an action upon an operator by a user;
an photographing section that takes a photograph of a photographing object and generates image data; and
a display section that holds a display of the image data generated by the photographing section after the operation detection section detects a start of the operation, until an end of the operation is detected, and finishes the display of the image data when the operation detection section detects the end of the operation.

2. The photographed image display apparatus according to claim 1, wherein the operator comprises a button and detects a start of the operation by an act of pressing the button by the user and detects an end of the operation by an act of releasing the pressed button by the user.

3. The photographed image display apparatus according to claim 1, wherein the display section displays the image data rotated in a predetermined direction.

4. The photographed image display apparatus according to claim 1, wherein the operation detection section comprises a plurality of operators and the display section displays the image data rotated in a predetermined direction associated with each of the operators.

5. The photographed image display apparatus according to claim 1, further comprising:
an image saving section that saves the image data; and
an photographing notifying section that notifies to the surrounding that a photograph is being taken, based on the detection by the operation detection section,
wherein the photographing notifying section performs different notifying operations depending on whether the image saving section saves the image data or the image saving section does not save the image data.

6. The photographed image display apparatus according to claim 5, wherein:
the image saving section comprises a save switch section that switches between saving and not saving the image data; and
the photographing notifying section issue a notification when the save switch section is switched so as to save the image data, and does not issue a notification when the save switch section is switched so as not to save the image data.

7. A photographed image display method comprising:
a first step of detecting an operation of displaying image data by an action on an operator by the user;
a second step of taking a photograph of a photographing object and generating image data;
a third step of holding a display of the image data generated when a start of the operation is detected;
a fourth step of detecting an end of the operation; and
a fifth step of finishing the display of the image data when the end of the operation is detected.

8. The photographed image display method according to claim 7, wherein, in the second step, the image data is displayed rotated in a predetermined direction.

9. The photographed image display method according to claim 7, wherein, in the second step, the image data is displayed rotated in a predetermined direction associated with each operator.
